(19) United States
(12) Patent Application Publication
(10) Pub. No.: US 2026/0175399 A1
(43) Pub. Date: Jun. 25, 2026

(54) COLLET WRENCH FOR CUT-OUT TOOL

(71) Applicant: MILWAUKEE ELECTRIC TOOL CORPORATION, Brookfield, WI (US)

(72) Inventors: Connor D. Sreenan, Wauwatosa, WI (US); Cole J. Engebretson, Milwaukee, WI (US)

(21) Appl. No.: 19/425,607

(22) Filed: Dec. 18, 2025

Related U.S. Application Data
(60) Provisional application No. 63/737,935, filed on Dec. 23, 2024.

(51) Int. Cl. B25F 5/02; B25B 13/50

(52) U.S. Cl. CPC B25F 5/02; B25B 13/50

(57) ABSTRACT

A power tool includes a housing, a drive shaft positioned within the housing, and a bit holder positioned adjacent a distal end of the housing and driven by rotation of the drive shaft. The bit holder includes a spindle coupled to the drive shaft, a collet positioned within the spindle, and a nut threadably coupled to the spindle. Movement of the nut relative to the spindle adjusts an opening of the collet. The tool additionally includes a cylinder coupled to the housing, and a wrench positioned within the cylinder for adjusting the bit holder. The wrench is axially movable between a first position where the wrench is coupled to the nut, and a second position where the wrench disengages the nut.

### CROSS-REFERENCE TO RELATED APPLICATIONS

This application claims priority to U.S. Provisional Application No. 63/737,935, filed December 23, 2024, the entire contents of which is incorporated herein by reference.

### FIELD

The present disclosure relates to power tools, and more particularly to cut-out tools.

### BACKGROUND

Cut-out power tools typically include a housing, a power supply positioned within the housing, a motor positioned within the housing, and a bit holder disposed on a distal end of the housing. Cut-out tools may accept a desired bit within the bit holder and may be used to drill holes, cut curves, or create other shapes in drywall, among other things.

### SUMMARY

In one aspect, a power tool includes a housing, a drive shaft positioned within the housing, a bit holder positioned adjacent a distal end of the housing and driven by rotation of the drive shaft, the bit holder including a spindle coupled to the drive shaft, a collet positioned within the spindle, and a nut threadably coupled to the spindle, wherein movement of the nut relative to the spindle adjusts an opening of the collet, and a cylinder coupled to the housing, a wrench positioned within the cylinder for adjusting the bit holder, wherein the wrench is axially movable between a first position where the wrench is coupled to the nut, and a second position where the wrench disengages the nut.

In another aspect, a power tool includes a housing, a motor disposed within the housing, the motor including a drive shaft rotatably driven by the motor, a spindle positioned within the housing and driven by the drive shaft, a bit holder positioned adjacent a distal end of the housing and driven by rotation of the drive shaft, a wrench coupled to the housing and including a protrusion, wherein the wrench is axially movable between a first position where the wrench is coupled to the bit holder, and a second position where the wrench disengages the bit holder, and a spindle lock assembly positioned on the housing and configured to selectively prevent rotation of the spindle, wherein the spindle lock assembly is configured to engage the protrusion to move the wrench from the first position to the second position.

In yet another aspect, a power tool includes a housing defining a first end, a second end opposite the first end, and a longitudinal axis extending through the first end and the second end, a handle positioned on the housing between the first end and the second end, a battery pack positioned on the second end of the housing, a drive shaft positioned within the housing along the longitudinal axis, a bit holder positioned adjacent the first end of the housing and driven by rotation of the drive shaft, and a wrench assembly for adjusting the bit holder, the wrench assembly positioned adjacent the first end of the housing, wherein the housing includes a channel extending from the handle to the first end of the housing, wherein the channel is tapered toward the first end of the housing.

Other features and aspects of the disclosure will become apparent by consideration of the following detailed description and accompanying drawings.

### BRIEF DESCRIPTION OF THE DRAWINGS

FIG. 1 is a perspective view of a cut-out tool according to one embodiment of the disclosure.

FIG. 2 is a cross-sectional view of the cut-out tool of FIG. 1 with a cylinder removed.

FIG. 3A is an enlarged cross-sectional view of the cut-out tool of FIG. 1 with a wrench in a first position and a spindle lock in an unlocked position.

FIG. 3B is another enlarged cross-sectional view of the cut-out tool of FIG. 1 with the wrench in a second position and the spindle lock in the unlocked position.

FIG. 3C is another enlarged cross-sectional view of the cut-out tool of FIG. 1 with the wrench in the first position and the spindle lock a locked position.

FIG. 3D is another enlarged cross-sectional view of the cut-out tool of FIG. 1 with the wrench in the second position and the spindle lock the unlocked position.

FIG. 4A is a top view of the cut-out tool of FIG. 1 with the wrench in the first position.

FIG. 4B is a top view of the cut-out tool of FIG. 1 with the wrench in the second position.

FIG. 5A is a top perspective view of the wrench of the cut-out tool of FIG. 1.

FIG. 5B is a bottom perspective view of the wrench of FIG. 5A.

FIG. 6 is an exploded perspective view of the wrench and a bit holder of the cut-out tool of FIG. 1.

FIG. 7 is an enlarged cross-sectional view of the bit holder of the cut-out tool of FIG. 1.

FIG. 8 is an enlarged cross-sectional view of the cut-out tool of FIG. 1.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

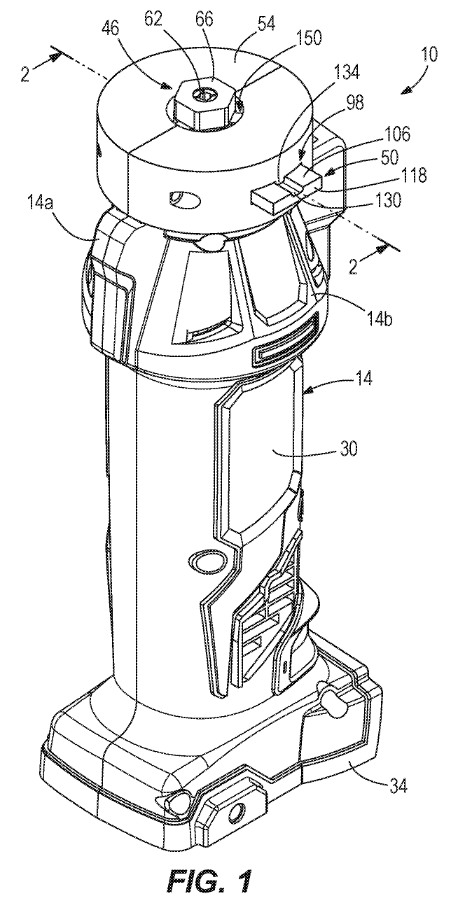

FIGS. 1-8 illustrate a cut-out tool 10 according to one embodiment. The cut-out tool 10 may be used for cutting into a variety of surfaces including drywall, etc. The cut-out tool 10 may include a generally cylindrical main body, or housing 14. In the illustrated embodiment, the main body 14 is a clamshell housing including a first portion 14a and a second portion 14b coupled via various fasteners (e.g., screws) supported by screw bosses extending through the first portion 14a and the second portion 14b.

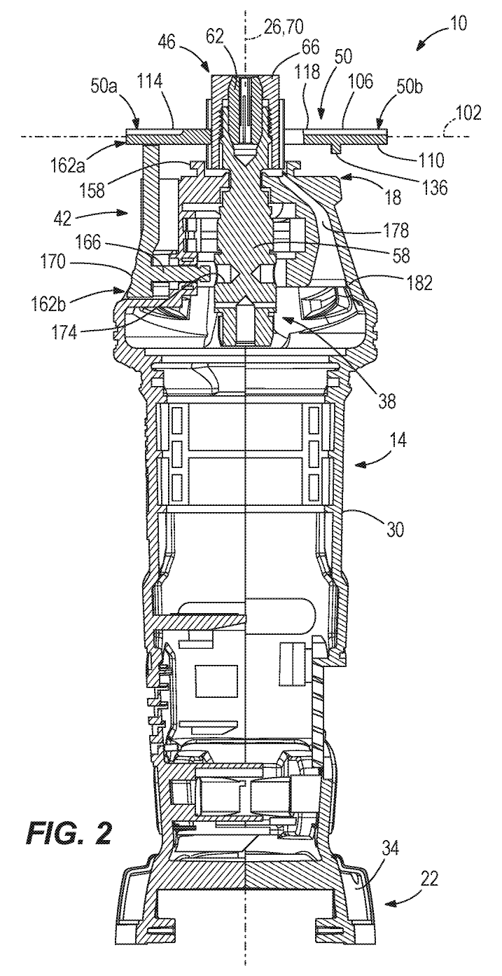

With reference to FIG. 2, the main body 14 includes a first end 18, a second end 22 opposite the first end 18, and a longitudinal axis 26 extending through the first and second ends 18, 22. The first end 18 may be further understood as a distal working end configured to contact a workpiece. The second end 22 may be further understood as a proximal end. The main body 14 further defines a handle, or grip portion, 30 positioned between the first end 18 and the second end 22 and graspable by a user to operate the cut-out tool 10.

In the embodiment described herein, the cut-out tool 10 is an entirely handheld unit which houses a battery and a motor within the body of the cut-out tool 10. The battery may be removably attached to a battery connection portion 34 (e.g., a receptacle) positioned on the main body 14. The battery is a power source that may be operably connected to the motor for providing power hereto. In some embodiments, the battery may include one or more battery cells. For example, the battery pack may be a 12-volt battery pack and may include three (3) Lithium-ion battery cells. In other embodiments, the battery pack may include fewer or more battery cells such that the battery pack is a 14.4-volt battery pack, an 18-volt battery pack, or the like. Additionally, or alternatively, the battery cells may have chemistries other than Lithium-ion such as, for example, Nickel Cadmium, Nickel Metal-Hydride, or the like. Additionally, or alternatively, the cut off tool 10 may use a power source such as a cord providing an alternating current power supply, e.g., from a utility source such as a standard outlet, and may include a transformer as necessary.

The main body 14 includes a power actuator positioned on the second end 22 of the tool 10 that is operable to turn the cut-out tool 10 on and off. The power actuator may be movably coupled with the main body 14 and may be actuatable to power the motor, e.g., to electrically couple the battery pack and the motor to run the motor. The power actuator may be a slider, a trigger-style actuator, a button, a lever, a knob, etc.

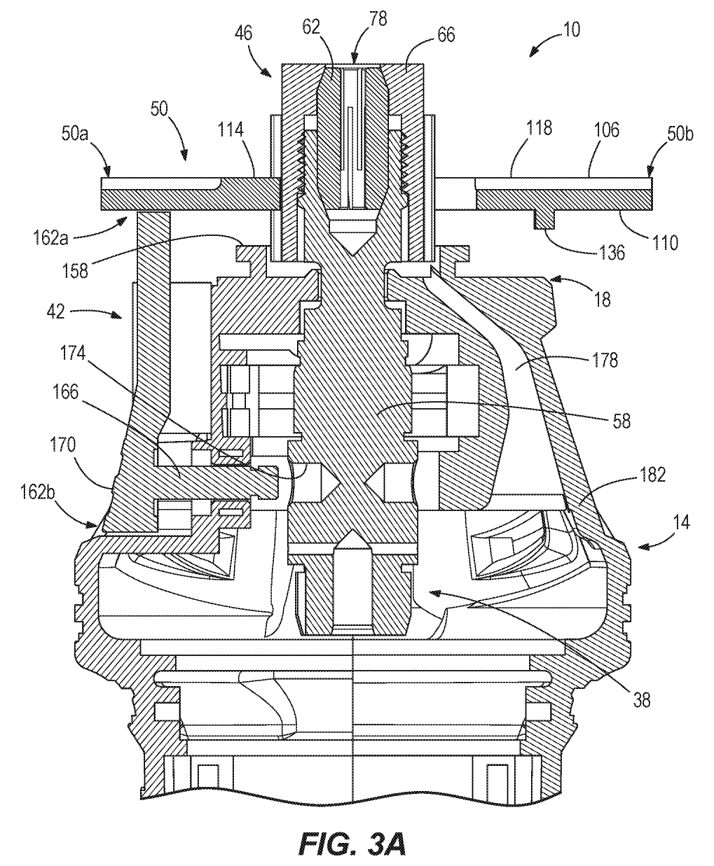

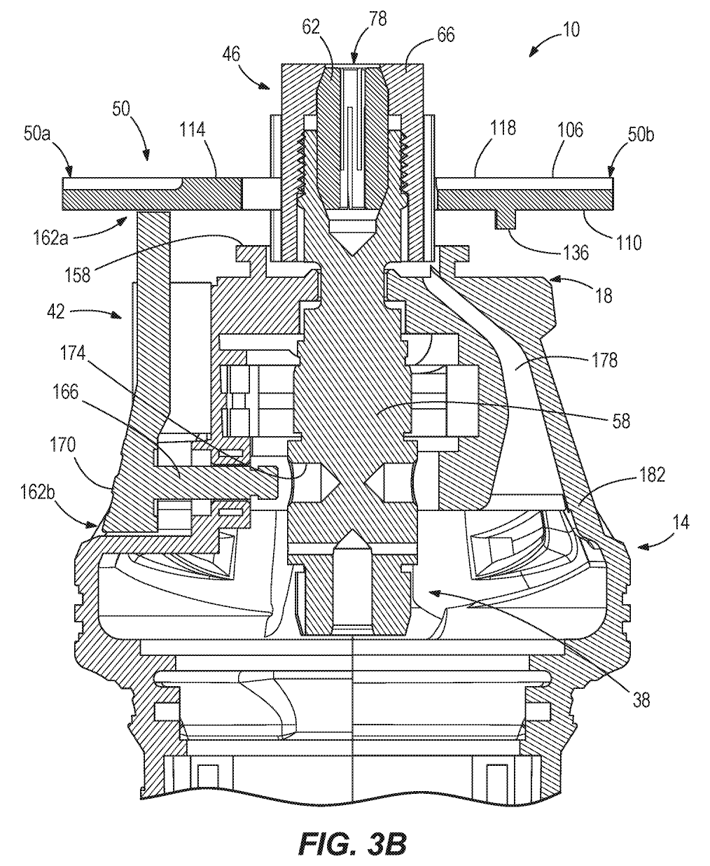

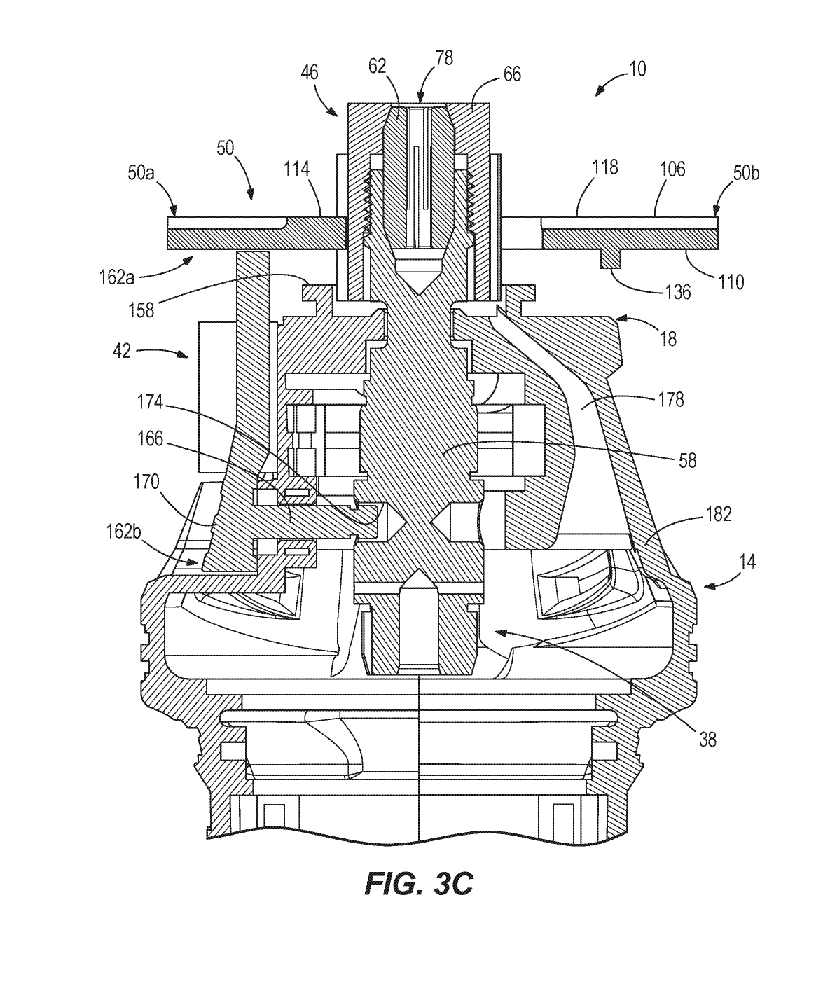

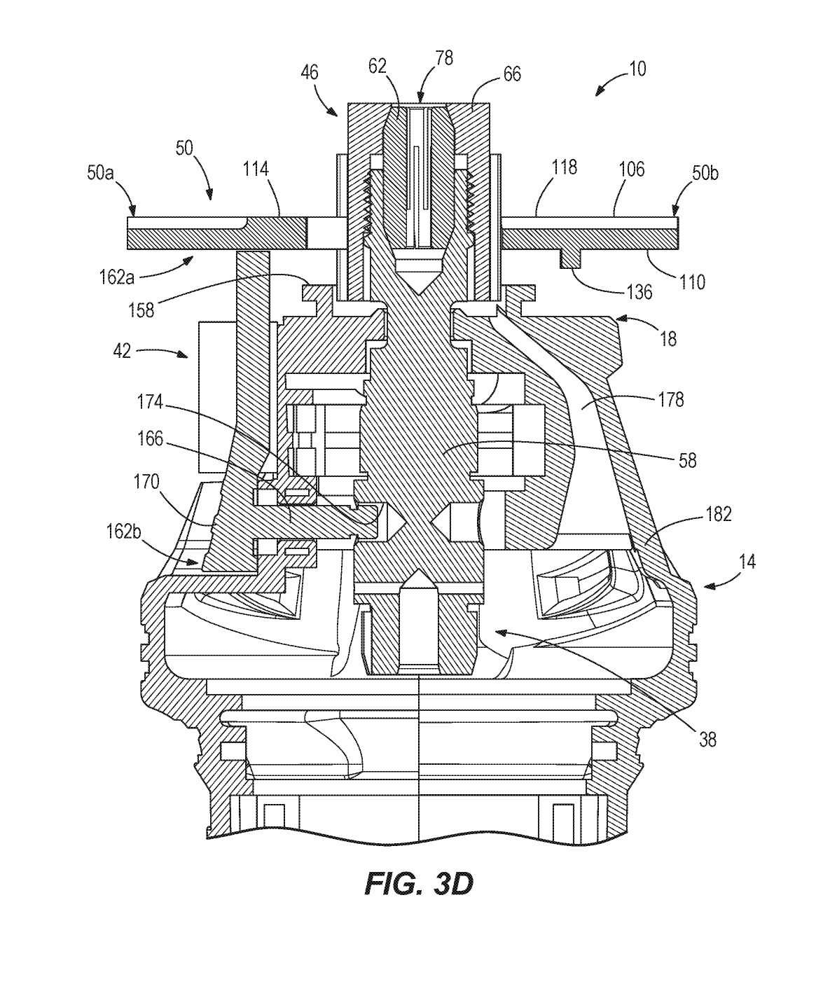

With reference to FIGS. 2 and 3A-3D, the cut-out tool 10 includes a drive shaft 38 positioned within the main body 14. The drive shaft 38 defines the longitudinal axis 26 and may be rotatably connected to a motor shaft that causes rotation of the drive shaft 38. The cut- out tool 10 additionally includes a spindle lock 42 positioned adjacent to the drive shaft 38, as discussed in more detail below. The spindle lock 42 is configured to engage or disengage from the drive shaft 38 for causing the drive shaft 38 to respectively lock (e.g., not rotate) or unlock (e.g., rotate). In this way, the drive shaft 38 may be locked, for example, when a bit is being released or clamped within a bit holder assembly 46. The drive shaft 38 may be connected to the bit holder assembly 46 and rotates a bit disposed in the bit holder assembly 46.

The first end 18 of the cut- out tool 10 includes the bit holder assembly 46, an onboard collet wrench 50 and a cylinder 54. With reference to FIGS. 2, 3A-3D, and 6, the bit holder assembly 46 is configured to support a working tool bit and includes a spindle 58, a collet 62, and collet nut 66. The bit holder assembly 46 may removably accept any one of a variety of bits and retain the bit during use of the cut- out tool 10. Portions of the bit holder assembly 46 may be caused to rotate and, thus, rotate the bit disposed therein for performing an operation (e.g., a cutting operation).

The spindle 58 is connected (i.e., integrally formed) to and configured to rotate with the drive shaft 38. The spindle 58 defines an axis of rotation 70 (FIG. 2) that is coaxial with the longitudinal axis 26. The spindle 58 includes a bore 74 configured to receive at least a portion of the collet 62. An outer surface of a distal end of the spindle 58 is threaded such that the spindle 58 is threadably coupled to the collet nut 66.

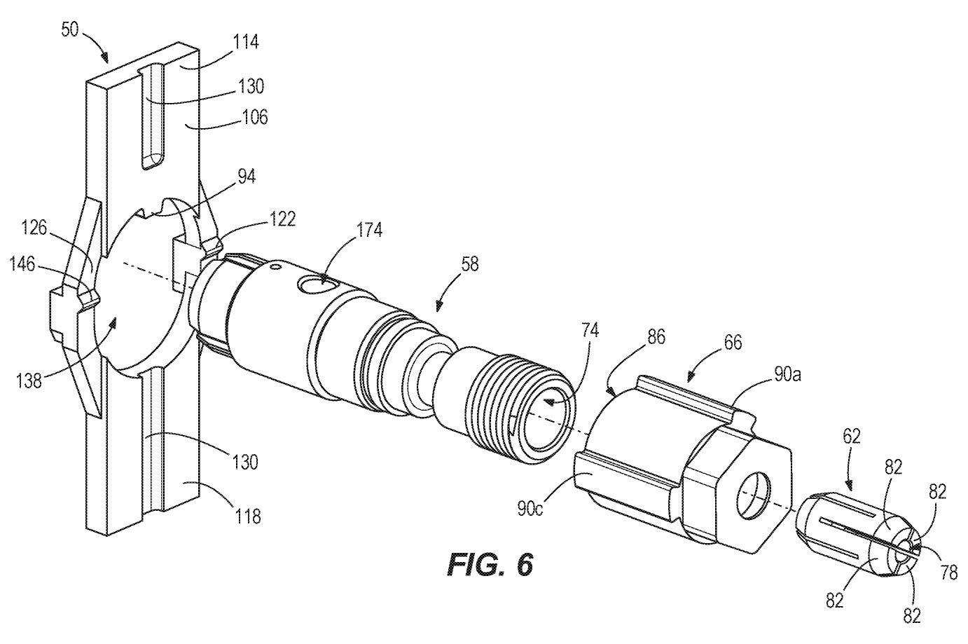

With reference to FIG. 6, the collet 62 is substantially cylindrical and includes an aperture 78 extending therethrough to receive a bit. The collet 62 may include at least two arms 82, each having a substantially beveled surface. The arms 82 of the collet 62 may be tightened or loosened respective to a bit by way of rotating the drive shaft 38.

With continued reference to FIG. 6, the collet nut 66 is threadably coupled to the spindle 58. The collet nut 66 is substantially cylindrical and includes a threaded aperture 86, which threadably engages the outer surface of a distal end of the spindle 58. The collet nut 66 may be rotatable relative to the spindle 58 between a clamped position and an unclamped position. A distal end of the collet nut 66 includes a surface that aligns with a corresponding surface of the collet arms 82. When the collet nut 66 is in the clamped position, the inner surface of the collet nut 66 exerts pressure on the collet 62, moving the collet arms 82 radially inward to apply a clamping force on a bit. When the collet nut 66 is in the unclamped position, the bit is unclamped or unrestrained and movable within the aperture 78 of the collet 62.

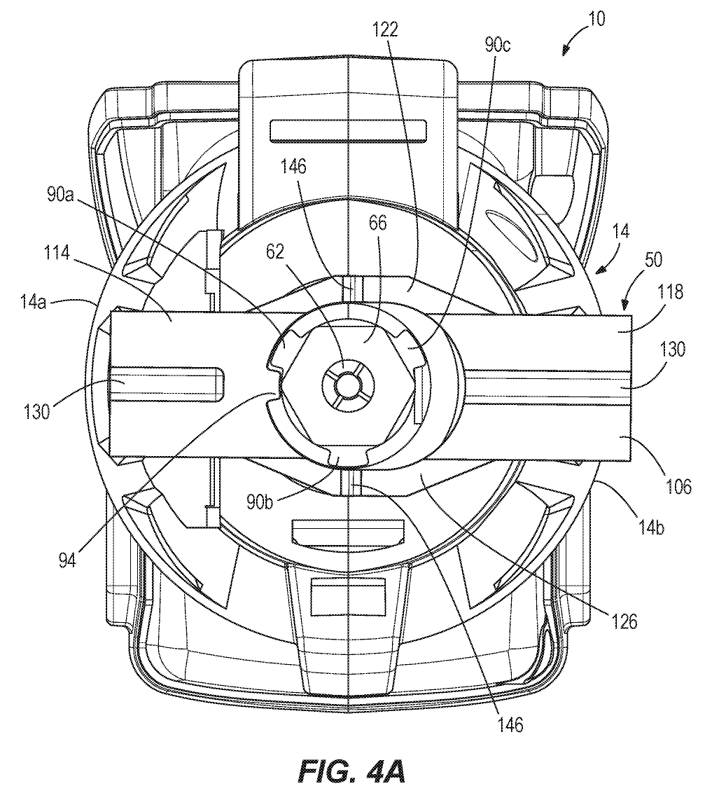

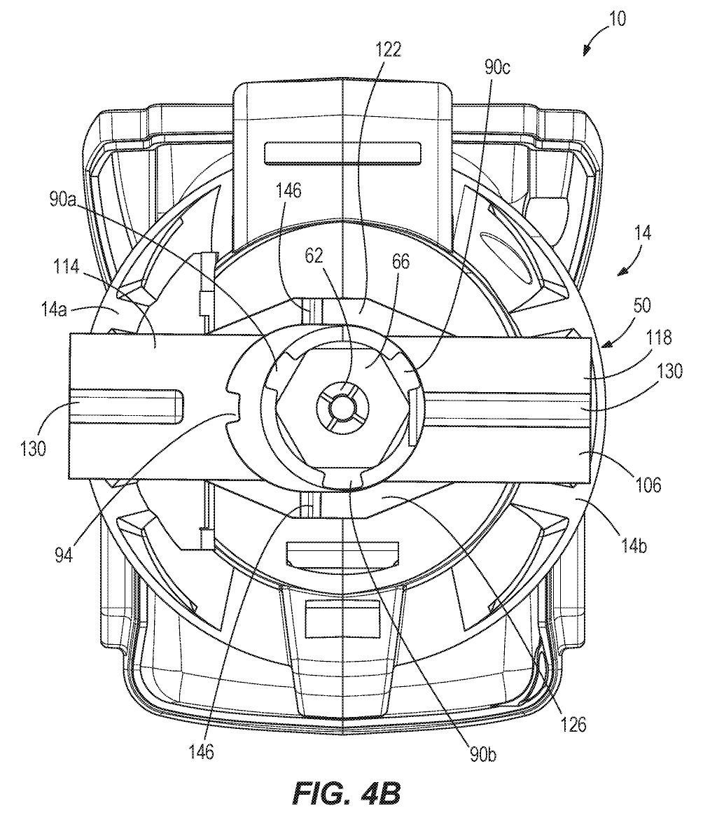

With reference to FIGS. 4A-4B, an outer surface of the collet nut 66 includes three diametrically spaced teeth – a first tooth 90a, a second tooth 90b, and a third tooth 90c. The teeth 90a-c protrude from the outer surface of the collet nut 66 and are shaped and size to receive a corresponding tooth 94 on the collet wrench 50. In some embodiments, the collet nut 66 may include fewer or additional teeth. Further, in some embodiments, the teeth may include alternative configurations and shapes.

The collet wrench 50 is removably coupled to the main body 14 to tighten or untighten the collet nut 66. More specifically, the collet wrench 50 is positioned within the cylinder 54, which is coupled to the first end 18 of the housing 14. Therefore, the rotary tool 10 may not require an auxiliary wrench to change working tool bits. The integrated collet wrench 50 may allow for quick accessory changes with the included collet 62 which is compatible with standard size accessories. As illustrated in FIG. 1, the collet wrench 50 is coupled to and positioned within a guide slot 98 of the cylinder 54.

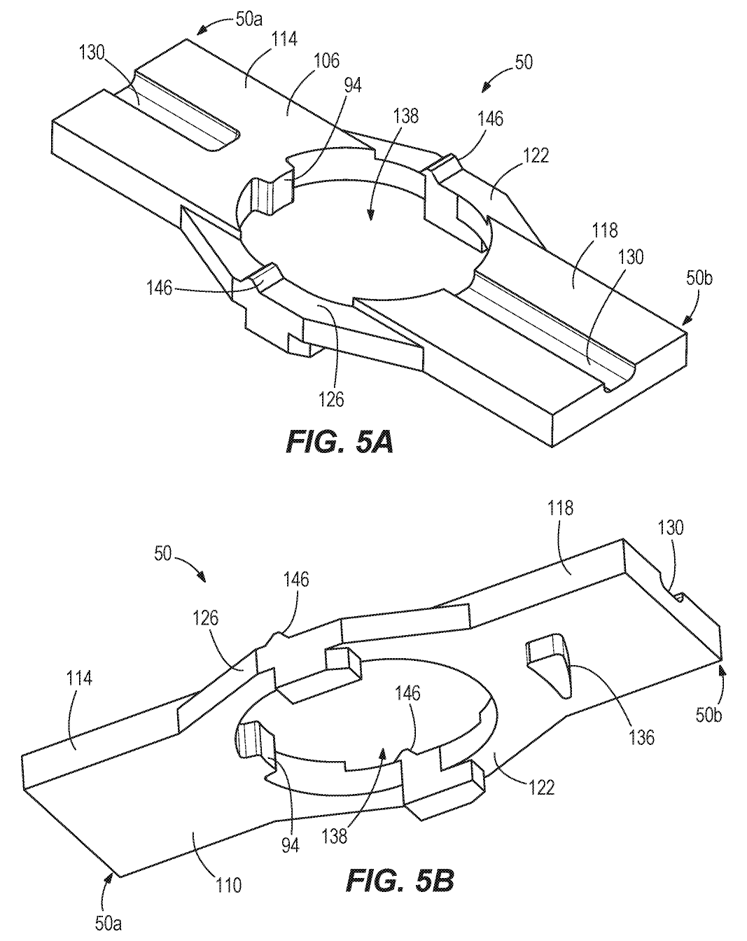

With reference to FIGS. 5A-5B, the collet wrench 50 includes a first end 50a, a second end 50b, and an axis 102 extending through the first and second ends 50a, 50b. The axis 102 is substantially perpendicular to the longitudinal axis 26 of the cut-out tool 10, such that the collet wrench 50 is oriented substantially perpendicular to the longitudinal axis 26. The collet wrench 50 additionally includes a first, upper surface 106, a second, bottom surface 110 opposite the first surface 106, a first arm 114, a second arm 118, a first curved arm 122, and a second curved arm 126. The first arm 114 is positioned adjacent to the first end 50a and the second arm 118 is positioned adjacent to the second end 50b. The first and second arms 114, 118 are substantially rectangular and are graspable by a user, allowing for easy manipulation and application of force. As shown in FIGS. 5A-5B, the first and second arms 114, 118 include a groove 130 extending into the upper surface 106 of the arms 114, 118. The groove 130 is generally rectangular and corresponds to a rail 134 positioned on the guide slot 98 of the cylinder 54, thereby coupling the collet wrench 50 to the cylinder 54 and preventing rotation of the collet wrench 50 relative to the cylinder 54.

The bottom surface 110 of the collet wrench 50 includes a cammed protrusion 136. The protrusion 136 includes an angled, or ramped, profile, allowing the protrusion 136 to guide and push on the spindle lock 42 as the collet wrench 50 rotates. More specifically, one of the edges of the protrusion 136 includes a gradual slope or incline, allowing it to apply a controlled lateral pressure when it contacts the spindle lock 42, as discussed in more detail below.

The first and second curved arms 122, 126 are positioned between the first arm 114 and the second arm 118, such that the first and second curved arms 122, 126 form an aperture 138 extending through the collet wrench 50. The aperture 138 is substantially elliptical and is shaped and sized to receive at least a portion of the collet nut 66. More specifically, the aperture 138 includes a maximum diameter slightly larger than a maximum diameter of the collet nut 66, such that the aperture 138 is generally elongated and sized to securely receive at least a portion of the collet nut 66. The aperture 138 includes the tooth 94 protruding into the aperture 138. In the illustrated embodiment, the tooth 94 is generally rectangular. However, in alternate embodiments, the tooth 94 may include different shapes and sizes. The tooth 94 includes a shape and size corresponding to the teeth 90a-c positioned on the collet nut 66, thereby temporarily coupling the collet wrench 50 to the collet nut 66 for corotation.

With reference to FIGS. 3A-3D and 4A-4B, the collet wrench 50 is axially movable along the collet wrench axis 102 between a first position, where the collet wrench 50 is engaged with the collet nut 66 (FIGS. 2, 3A, 3C, and 4A), and a second position, where the collet wrench 50 is disengaged with the collet nut 66 (FIGS. 3B, 3D, and 4B. When the collet wrench 50 is in the first position, the collet wrench tooth 94 engages the collet nut 66 and is positioned between the first tooth 90a and the second tooth 90b of the collet nut 66. More specifically, a side surface of the collet wrench tooth 94 abuts against a side surface of the first collet nut tooth 90a, and when the collet wrench 50 is in the second position, the collet wrench tooth 94 is spaced apart from the collet nut teeth 90a-c, thereby decoupling the collet wrench 50 from the collet nut 66.

With continued reference to FIG. 4A, when the collet wrench 50 is in the first position, the engagement between the collet wrench tooth 94 and the collet nut teeth 90a-c allows the collet wrench 50 to grip the collet nut 66 in such a way that any rotational force applied to the collet wrench 50 will transfer directly to the collet nut 66, and vice versa. If the collet wrench 50 is rotated in a first rotational direction (e.g., clockwise in the illustrated embodiments), the tooth 94 of the collet wrench 50 pushes against the first collet nut tooth 90a, transferring torque from the collet wrench 50 to the collet nut 66, causing the collet nut 66 to also rotate clockwise. Rotation of the collet nut 66 in the clockwise direction moves the collet nut 66 into the clamped position such that the collet nut 66 exerts pressure on the collet 62, moving the collet arms 82 radially inward to apply a clamping force on a bit.

Alternatively, if the collet wrench 50 is rotated in a second rotational direction (e.g., counterclockwise in the illustrated embodiments), the collet wrench tooth 94 disengages the first collet nut tooth 90a, causing the collet wrench tooth 94 to slide along a circumference of the collet nut 66 until the collet wrench tooth 94 engages a side surface of the second collet nut tooth 90b. Once the collet wrench tooth 94 and the second collet nut tooth 90b are in engagement, the collet wrench tooth 94 pushes against the second collet nut tooth 90b, transferring torque from the collet wrench 50 to the collet nut 66, causing the collet nut 66 to also rotate counterclockwise. Rotation of the collet nut 66 in the counterclockwise direction moves the collet nut 66 into the unclamped position such that the bit is unclamped or unrestrained and movable within the aperture 78 of the collet 62.

For normal operation of the tool 10, the collet wrench 50 must be in the second position to avoid interference from the collet wrench 50 during operation. If the user actuates the power actuator and the collet wrench 50 is in the first position, the collet wrench 50 rotates with the spindle 58. After rotating one-half rotation (e.g., 180 degrees), the protrusion 136 on the collet wrench 50 engages the spindle lock 42, which exerts a force on the collet wrench 50 and gradually moves the collet wrench 50 from the first position to the second position.

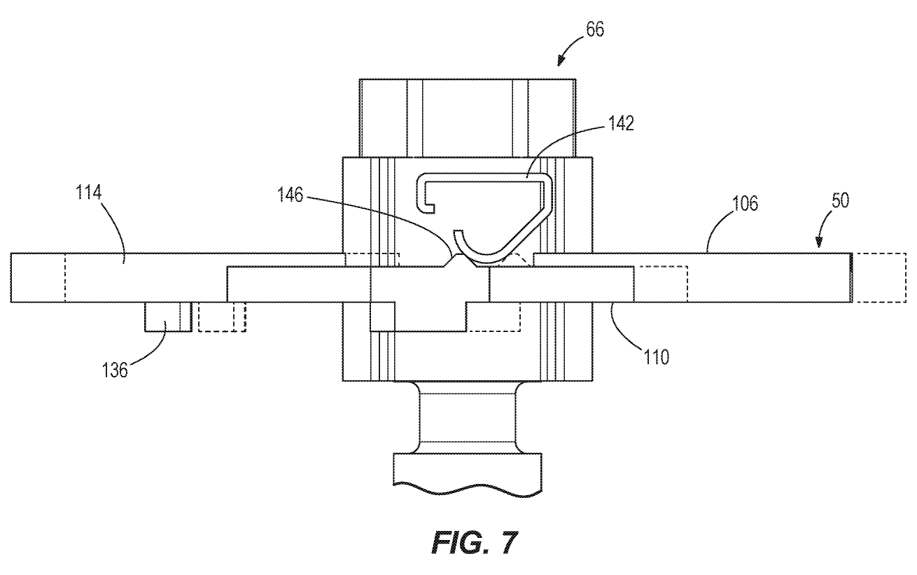

With reference to FIG. 7, the bit holder assembly 46 additionally includes a biasing member 142 coupled to the collet wrench 50. In the illustrated embodiments, the biasing member 142 is a snap spring that biases the collet wrench 50 into both the first position and the second position. The biasing member 142 ensures that the collet wrench 50 maintains its position, preventing unintentional shifts during operation. As shown in FIGS. 5A-5B, the first and second curved arms 122, 126 of the collet wrench 50 each include a notch 146. The notches 145 are shaped and sized to abut against the biasing member 142 in the first and second positions. More specifically, when the collet wrench 50 is rotated to either the first or second position, the biasing member 142 presses into the notches 146, securing the collet wrench 50 and preventing accidental movement. The engagement between the notches 146 and the biasing member 142 ensures that the collet wrench 50 remains stable in its intended position until sufficient force is applied to shift the collet wrench 50. As the collet wrench 50 is moved from the first position to the second position (and vice versa), the biasing member 142 momentarily disengages from the notches 146, then snaps back into place, providing tactile feedback that confirms the collet wrench 50 is secured locked in the new position.

With reference to FIG. 1, the cylinder 54 serves as a housing or retainer for the collet wrench 50. More specifically, the cylinder 54 provides structural alignment for the collet wrench 50 and maintains the position of the collet wrench 50 on the bit holder assembly 46. The cylinder 54 is generally cylindrical and is positioned on the first end 18 of the housing 14. The cylinder 54 includes a cylindrical bore 150 that extends through the cylinder 54 and is shaped and sized to receive the collet nut 66. The cylinder 54 includes a circumferential groove 154 shaped and sized to receive a corresponding lip 158 on the first end 18 of the housing 14. The connection between the circumferential groove 154 and the lip 158 allows the cylinder 54 to rotate relative to the housing 14.

The guide slot 98 of the cylinder 54 is substantially rectangular and extends through the cylinder 54. The guide slot 98 is shaped and sized to receive the collet wrench 50, such that the collet wrench 50 is axially slidable relative to the cylinder 54. The guide slot 98 includes the rail 134, which extends into the guide slot 98 and fits within the corresponding groove 130 on the upper surface 106 of the collet wrench 50. The connection between the rail 134 on the cylinder 54 and the groove 130 on the collet wrench 50 allows the collet wrench 50 to axially slide relative to the cylinder 54. The rail 134 and groove 130 also allow the collet wrench 50 and cylinder 54 to rotate together and prevent rotation of the collet wrench 50 relative to the cylinder 54.

With reference to FIGS. 2 and 3A-3D, the spindle lock 42 is positioned on the housing 14. The spindle lock 42 is substantially L-shaped and includes a first portion 162, a second portion 166, an actuator 170, and a biasing member (e.g., a spring). The first portion 162 is substantially rectangular and includes a first end 162a and a second end 162b opposite the first end 162a. The second portion 166 is substantially cylindrical and extends from the second end 162a of the first portion 162, such that the second portion 166 is oriented substantially perpendicular to the first portion 162. The second portion 166 is shaped and sized to be received within a corresponding aperture 174 of the spindle 58. The actuator 170 is positioned on the second end 162b of the first portion 162 and is depressible by a user to move the spindle lock 42 into engagement with the spindle 58.

The spindle lock 42 is movable between a locked position where the spindle lock 42 engages the spindle 58 (FIGS. 3C and 3D) and an unlocked position where the spindle lock 42 disengages the spindle 58 (FIGS. 2, 3A, and 3B). When the spindle lock 42 is in the locked position, the second portion 166 of the spindle 58 is inserted directly into the aperture 174 of the spindle 58, preventing the spindle 58 from rotating and thereby allowing the user to safely tighten or loosen the collet nut 66. Alternatively, when the spindle lock 42 is in the unlocked position, the second portion 166 of the spindle 58 is disengaged and spaced apart from the aperture 174 of the spindle 58, allowing the spindle 58 to rotate. When the spindle lock 42 is in the unlocked position, the spindle lock 42 is supported by the housing 14 and the handle 30 of the tool 10. The biasing member biases the spindle lock 42 to the disengaged position. To move the spindle lock 42 from the disengaged position to the engaged position, the user must exert a force on the spindle lock 42 sufficient to overcome the bias of the biasing member.

For normal operation of the tool 10, the spindle lock 42 must be disengaged to allow free rotation of the spindle 58. In the event that the user actuates the power actuator and the spindle lock 42 is engaged, the spindle 58, and therefore the collet nut 66, is held stationary, preventing any movement.

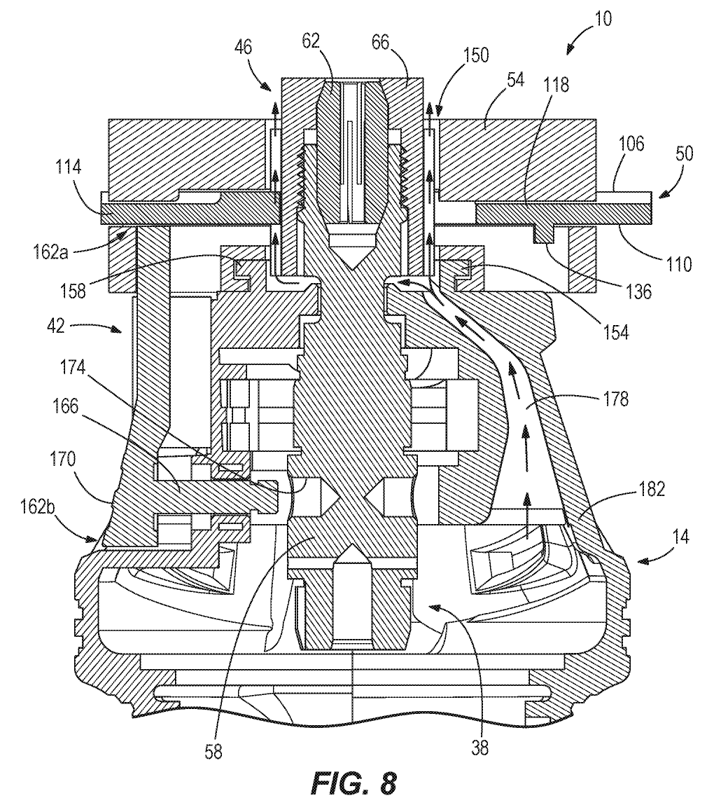

With reference to FIG. 8, the housing 14 is designed to facilitate venting, thereby preventing ingress of contaminants into the tool 10, enhancing accessibility for the user, and clearing the workspace. The housing 14 includes a channel 178 extending from the first end 18 of the housing 14 to a midpoint 182, which is adjacent to a distal end of the handle 30. More specifically, the housing 14 includes supports positioned along an inner surface of the housing 14 to form the channel 178 and block other airways. The channel 178 is substantially tapered toward the first end 18 of the housing 14. During operation, the channel 178 draws air through the tool 10 to dissipate heat and remove any generated contaminants. Specifically, the air flows through the channel 178 from the midpoint 182 toward the first end 18 of the housing 14, through the collet nut 66, and out of the tool 10. The channel 178 ensures that the primary airflow is directed away from the internal components of the tool 10. By rerouting the airflow, the housing 14 protects the internal components of the tool 10 and enhances overall cleanliness and accessibility.

During a bit installation and/or bit changing, the user manually presses the actuator 170 of the spindle lock 42, overcoming the bias of the biasing member and moving the spindle lock 42 into the locked position (FIGS. 3C and 3D). More specifically, the second portion 166 of the spindle lock 42 slides into the aperture 174 of the spindle 58, preventing the spindle 58, collet 62, and collet nut 66 from rotating. If the collet wrench 50 is in the second position (FIGS. 3B, 3D, and 4B) the user axially slides the collet wrench 50 relative to the cylinder 54 to the first position (FIGS. 2, 3A, 3C, and 4A), such that the collet wrench 50 is in engagement with the collet nut 66. The biasing member 142 engages the notches 146 on the collet wrench 50, securing the collet wrench 50 in the first position. The user then grasps the collet wrench 50 and turns the collet wrench 50 in the second rotational direction (e.g., counterclockwise). The collet wrench tooth 94 exerts torque on the second collet nut tooth 90b, thereby rotating the collet nut 66 in the second rotational direction. The collet nut 66 releases the collet 62, which subsequently relaxes and/or minimizes the compressive force exerted on the bit, allowing the bit to be removed from the bit holder assembly 46.

In order to secure the new bit within the collet 62, the user turns the collet wrench 50 in the first rotational direction (e.g., clockwise). The collet wrench tooth 94 slides along the circumference of the collet nut 66 until the collet wrench tooth 94 engages the first collet nut tooth 90a. The collet wrench tooth 94 exerts torque on the first collet nut tooth 90a, causing corresponding rotation and tightening of the collet nut 66 onto the collet 62. Because the spindle lock 42 is in the locked position, the spindle 58 remains stationary, allowing the user to tighten the collet nut 66 without causing the spindle 58 to rotate. After securing the bit, the user may release the actuator 170 of the spindle lock 42, allowing the biasing member to bias the spindle lock 42 to the unlocked position (FIGS. 2, 3A, and 3B). With the spindle lock 42 in the unlocked position, the spindle 58 is free to rotate when the tool 10 is powered on.

To operate the tool 10, the user engages the power actuator, which activates the motor and begins rotating the spindle 58. The rotation of the spindle 58 causes the bit holder assembly 46 to rotate, which causes the bit secured within the collet 62 to also rotate, allowing the bit to perform the intended operation. If the collet wrench 50 was unintentionally left in the first position upon actuation of the power actuator, the spindle 58 rotates, causing subsequent rotation of the collet nut 66 and the collet wrench 50. After approximately one-half rotation of the spindle 58, the protrusion 136 on the second surface 110 of the collet wrench 50 contacts the first portion 162 of the spindle lock 42. The spindle lock 42 exerts a force against the protrusion 136, causing the collet wrench 50 to axially move into the second position and out of engagement with the collet nut 66. The automatic disengagement feature prevents potential damage to the tool 10, such as excessive torque transfer to the wrench 50, unbalanced rotation, and increased wear on internal components. Additionally, the automatic disengagement feature reduces risks of overheating, inconsistent cutting, and the wrench 50 potentially being ejected during operation, thereby prolonging tool longevity and enhancing safety.

Although the invention has been described in detail with reference to certain preferred embodiments, variations and modifications exist within the scope and spirit of one or more independent aspects of the invention as described. Various features and advantages of the invention are set forth in the following claims.

What is claimed is:

1. A power tool comprising:
a housing;
a drive shaft positioned within the housing;
a bit holder positioned adjacent a distal end of the housing and driven by rotation of the drive shaft, the bit holder including
a spindle coupled to the drive shaft,
a collet positioned within the spindle, and
a nut threadably coupled to the spindle, wherein movement of the nut relative to the spindle adjusts an opening of the collet; and
a cylinder coupled to the housing;
a wrench positioned within the cylinder for adjusting the bit holder, wherein the wrench is axially movable between a first position where the wrench is coupled to the nut, and a second position where the wrench disengages the nut.

2. The power tool of claim 1, wherein when the wrench is rotatable relative to the housing.

3. The power tool of claim 2, wherein when the wrench is in the first position, the wrench and the nut are coupled for co-rotation, and when the wrench is in the second position, the wrench is rotatable relative to the nut.

4. The power tool of claim 2, wherein the wrench is axially movable relative to the cylinder, and wherein the wrench is coupled to the cylinder for co-rotation.

5. The power tool of claim 1, wherein the wrench includes a first tooth and the nut includes a second tooth.

6. The power tool of claim 5, and wherein when the wrench is in the first position, the first tooth is configured to engage the second tooth, and wherein when the wrench is in the second position, the first tooth is disengaged from the second tooth.

7. The power tool of claim 5, wherein the second tooth is one of a plurality of teeth positioned on the nut.

8. The power tool of claim 1, wherein the cylinder includes a rail and the wrench includes a slot, wherein the rail is configured to axially slide along the slot.

9. A power tool comprising:
a housing;
a motor disposed within the housing, the motor including a drive shaft rotatably driven by the motor;
a spindle positioned within the housing and driven by the drive shaft;
a bit holder positioned adjacent a distal end of the housing and driven by rotation of the drive shaft;
a wrench coupled to the housing and including a protrusion, wherein the wrench is axially movable between a first position where the wrench is coupled to the bit holder, and a second position where the wrench disengages the bit holder; and
a spindle lock assembly positioned on the housing and configured to selectively prevent rotation of the spindle;
wherein the spindle lock assembly is configured to engage the protrusion to move the wrench from the first position to the second position.

10. The power tool of claim 9, wherein the spindle lock assembly is movable between a first position where the spindle lock assembly engages the spindle, and a second position where the spindle lock assembly disengages the spindle.

11. The power tool of claim 10, wherein the spindle includes an aperture, and wherein when the spindle lock assembly is in the first position, a portion of the spindle is positioned within the aperture.

12. The power tool of claim 10, wherein the spindle lock assembly is configured to engage the protrusion when the spindle lock assembly is in the second position.

13. The power tool of claim 10, wherein when the spindle lock assembly is in the second position, the spindle lock assembly is supported by the housing.

14. The power tool of claim 9, wherein the protrusion includes a cammed surface.

15. The power tool of claim 9, wherein when the wrench is in the first position, the wrench and a portion of the bit holder are coupled for co-rotation, and when the wrench is in the second position, the wrench is rotatable relative to the bit holder.

16. A power tool comprising:
a housing defining a first end, a second end opposite the first end, and a longitudinal axis extending through the first end and the second end;
a handle positioned on the housing between the first end and the second end;
a battery pack positioned on the second end of the housing;
a drive shaft positioned within the housing along the longitudinal axis;
a bit holder positioned adjacent the first end of the housing and driven by rotation of the drive shaft; and
a wrench for adjusting the bit holder, the wrench positioned adjacent the first end of the housing;
wherein the housing includes a channel extending from the handle to the first end of the housing, wherein the channel is configured to direct airflow from the second end of the housing to the first end of the housing and through the bit holder.

17. The power tool of claim 16, wherein the channel is tapered toward the first end of the housing.

18. The power tool of claim 16, wherein the wrench is movable between a first position where the wrench is coupled to the bit holder, and a second position where the wrench disengages the bit holder.

19. The power tool of claim 18, wherein when the wrench is in the first position, the wrench and a portion of the bit holder are coupled for co-rotation, and when the wrench is in the second position, the wrench is rotatable relative to the bit holder.

20. The power tool of claim 16, wherein the bit assembly includes a spindle coupled to the drive shaft, a collet positioned within the spindle, and a nut threadably coupled to the spindle.
